(19) United States
(12) Patent Application Publication
(10) Pub. No.: US 2023/0347819 A1
(43) Pub. Date: Nov. 2, 2023

(54) NOISE GENERATOR

(71) Applicant: Rivian IP Holdings, LLC, Irvine, CA (US)

(72) Inventors: Baojin Wang, San Marcos, CA (US); Michael Wiedemann, Ypsilanti Township, MI (US); Armaghan Mogouei, Seattle, WA (US)

(21) Appl. No.: 17/730,531

(22) Filed: Apr. 27, 2022

(51) Int. Cl. B60Q 5/00; F16K 17/00; H01M 50/35

(52) U.S. Cl. CPC B60Q 5/005; F16K 17/003; H01M 50/35; H01M 2220/20

(57) ABSTRACT

The present disclosure is directed to an apparatus. The apparatus can include a first conduit coupled with the battery pack. The apparatus can include a first valve coupled with the first conduit. The first valve can allow gas to pass from the battery pack through the first valve at a first pressure. The apparatus can include a second valve coupled with the first conduit and with a second conduit. The second valve can allow the gas to pass at a second pressure. The second pressure can be greater than the first pressure. The apparatus can include a noise generating element coupled with the second conduit. The noise generating element can activate based on the second pressure.

### INTRODUCTION

A vehicle can include various components that produce gas. For example, electric vehicles can include one or more batteries that produce gas.

### SUMMARY

Under certain conditions, electric vehicle battery packs can generate gas. Systems and methods described herein can alert an occupant of a vehicle or a nearby bystander to the existence of gas generation. At least one aspect of the present disclosure is directed to a mechanical noise generating system. The noise generating system can include a first conduit coupled with a portion of a battery pack and a first valve coupled with the first conduit. The first valve can allow gas flowing from the battery pack through the first conduit to pass at or above a first pressure. The noise generating system can include a second valve coupled with the first conduit and with a second conduit. The second valve can allow the gas to pass at or above a second pressure in which the second pressure is associated with a thermal event. The noise generating system can include at least one noise generating element to generate an audible sound based on the second pressure, in which the audible sound is detectable outside of the battery pack to indicate the thermal event.

At least one aspect is directed to an apparatus. The apparatus can include a first conduit coupled with a battery pack. The apparatus can include a first valve coupled with the first conduit. The first valve can allow gas to pass from the battery pack through the first valve at a first pressure. The apparatus can include a second valve coupled with the first conduit and with a second conduit. The second valve can allow the gas to pass at a second pressure. The second pressure can be greater than the first pressure. The apparatus can include a noise generating element coupled with the second conduit. The noise generating element can activate based on the second pressure.

At least one aspect is directed to a method. The method can include actuating, at a first pressure, a first valve coupled with a first conduit. The first valve can allow gas to pass from a battery pack through the first valve. The method can include actuating, at a second pressure greater than the first pressure, a second valve coupled with the first conduit and with a second conduit. The method can include activating a noise generating element coupled with the second conduit based on the second pressure.

At least one aspect is directed to an electric vehicle. The electric vehicle can include an apparatus. The apparatus can include a first conduit coupled with a battery pack. The apparatus can include a first valve coupled with the first conduit. The first valve can allow gas to pass from the battery pack through the first valve at a first pressure. The apparatus can include a second valve coupled with the first conduit and with a second conduit. The second valve can allow the gas to pass at a second pressure. The second pressure can be greater than the first pressure. The apparatus can include a noise generating element coupled with the second conduit. The noise generating element can activate based on the second pressure.

At least one aspect is directed to a battery pack system. The battery pack system can include a battery pack. The battery pack system can include an apparatus. The apparatus can include a first conduit coupled with the battery pack. The apparatus can include a first valve coupled with the first conduit. The first valve can allow gas to pass from the battery pack through the first valve at a first pressure. The apparatus can include a second valve coupled with the first conduit and with a second conduit. The second valve can allow the gas to pass at a second pressure. The second pressure can be greater than the first pressure. The apparatus can include a noise generating element coupled with the second conduit. The noise generating element can activate based on the second pressure.

At least one aspect is directed to a method. The method can include providing a system for a battery pack. The system can include a first conduit coupled with the battery pack. The system can include a first valve coupled with the first conduit. The first valve can allow gas to pass from the battery pack through the first valve at a first pressure. The system can include a second valve coupled with the first conduit and with a second conduit. The second valve can allow the gas to pass at a second pressure. The second pressure can be greater than the first pressure. The system can include a noise generating element coupled with the second conduit. The noise generating element can activate based on the second pressure.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle, in accordance with implementations.

FIG. 2A depicts an example battery pack, in accordance with implementations.

FIG. 2B depicts example battery modules, in accordance with implementations.

FIG. 3 depicts another example perspective view of a system, in accordance with implementations.

FIG. 4 depicts an example perspective view of a system, in accordance with implementations.

FIG. 5 depicts an example top view of the system of FIG. 3, in accordance with implementations.

FIG. 6 depicts an example top view of the system of FIG. 4, in accordance with implementations.

FIG. 7 depicts an example illustration of a process, in accordance with implementations.

FIG. 8 depicts an example illustration of a process, in accordance with implementations.

### DETAILED DESCRIPTION

Following below are more detailed descriptions of various concepts related to, and implementations of, methods, apparatuses, and systems of a noise generating element. The various concepts introduced above and discussed in greater detail below may be implemented in any of numerous ways.

The present disclosure is directed to at least one mechanical system for detecting a thermal event within a battery pack of a vehicle and alerting occupants of the electric vehicle of the thermal event. The system can include a first conduit (e.g., tube) coupled with a battery pack. The system can include a first valve and a second valve each coupled with the first conduit. The first valve can actuate at or above a first fluid pressure (e.g., to allow various gases to escape from the battery pack). The second valve can actuate at or above a second fluid pressure that is greater than the first fluid pressure (e.g., to allow gases associated with a thermal event to escape from the first conduit associated with the battery pack). The system can include a second conduit (e.g., tube) coupled with the second valve. The system can include a third valve coupled with the second conduit. The third valve can actuate with or after actuation of the second valve. The system can include a whistle that activates responsive to actuation of the third valve to generate an audible sound (e.g., via gas flowing through the whistle). The third valve can remain open at a third fluid pressure to cause the whistle to activate for a period of time. The system can additionally or alternatively include a plurality of projections coupled with a portion of the second conduit or with the second valve such that gas flowing through the second valve causes at least a portion of the plurality of projections to move relative to the second conduit or second valve to cause an audible sound (e.g., via the plurality of projections contacting one another or another portion of the system).

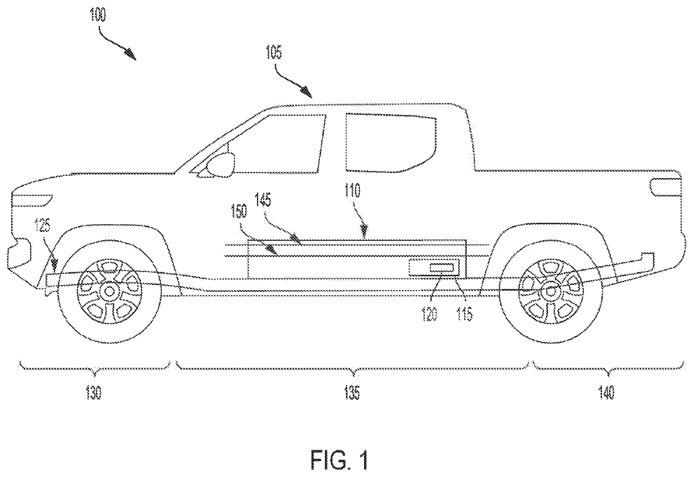

FIG. 1 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric bicycles, electric scooters, electric passenger vehicles, electric passenger or commercial trucks, hybrid vehicles, high voltage (e.g., greater than 60 V) or low voltage (e.g., less than 60 V) electric vehicles, or other vehicles such as sea or air transport vehicles, planes, helicopters, submarines, boats, or drones (e.g., delivery drones), among other possibilities. The battery pack 110 can also be used as an energy storage system to power a building, such as a residential home or commercial building, or various devices, such as a computer or mobile device. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

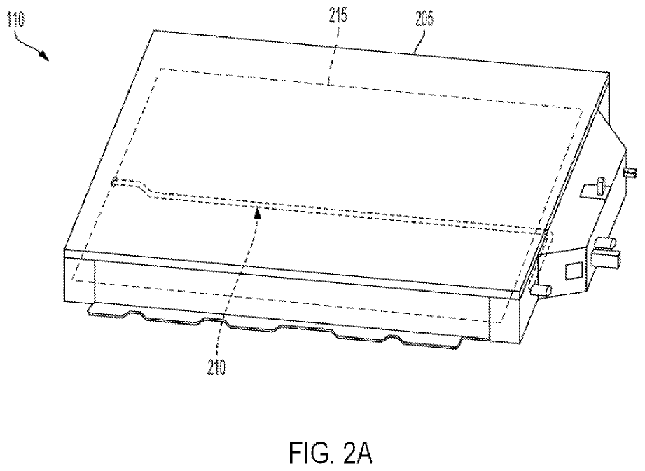

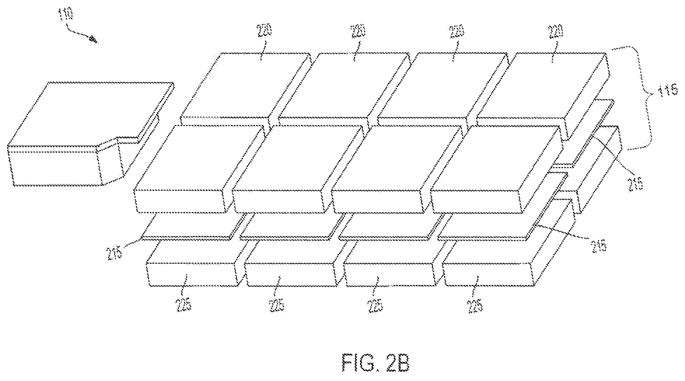

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one cold plate 215. The cold plate 215 can be positioned in relation to a top submodule and a bottom submodule, such as in between the top and bottom submodules, among other possibilities. The battery pack 110 can include any number of cold plates 215. For example, there can be one or more cold plates 215 per battery pack 110, or per battery module 115. At least one cooling line 210 can be coupled with, part of, or independent from the cold plate 215.

FIG. 2B depicts example battery modules 115. The battery modules 115 can include at least one submodule. For example, the battery modules 115 can include at least one top submodule 220 or at least one bottom submodule 225. At least one cold plate 215 can be disposed between the top submodule 220 and the bottom submodule 225. For example, one cold plate 215 can be configured for heat exchange with one battery module 115. The cold plate 215 can be disposed or thermally coupled between the top submodule 220 and the bottom submodule 225. One cold plate 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells, pouch cells, or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a cold plate 215 in between the top submodule 220 and the bottom submodule 225. The battery pack 110 can include or define a plurality of areas for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

Battery cells 120 have a variety of form factors, shapes, or sizes. For example, battery cells 120 can have a cylindrical, rectangular, square, cubic, flat, or prismatic form factor. Battery cells 120 can be assembled, for example, by inserting a winded or stacked electrode roll (e.g., a jelly roll) including electrolyte material into at least one battery cell housing. The electrolyte material, e.g., an ionically conductive fluid or other material, can generate or provide electric power for the battery cell 120. A first portion of the electrolyte material can have a first polarity, and a second portion of the electrolyte material can have a second polarity. The housing can be of various shapes, including cylindrical or rectangular, for example. Electrical connections can be made between the electrolyte material and components of the battery cell 120. For example, electrical connections with at least some of the electrolyte material can be formed at two points or areas of the battery cell 120, for example to form a first polarity terminal (e.g., a positive or anode terminal) and a second polarity terminal (e.g., a negative or cathode terminal). The polarity terminals can be made from electrically conductive materials to carry electrical current from the battery cell 120 to an electrical load, such as a component or system of the electric vehicle 105.

For example, the battery cell 120 can include a lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Yet further, some battery cells 120 can be solid state battery cells and other battery cells 120 can include liquid electrolytes for lithium-ion battery cells.

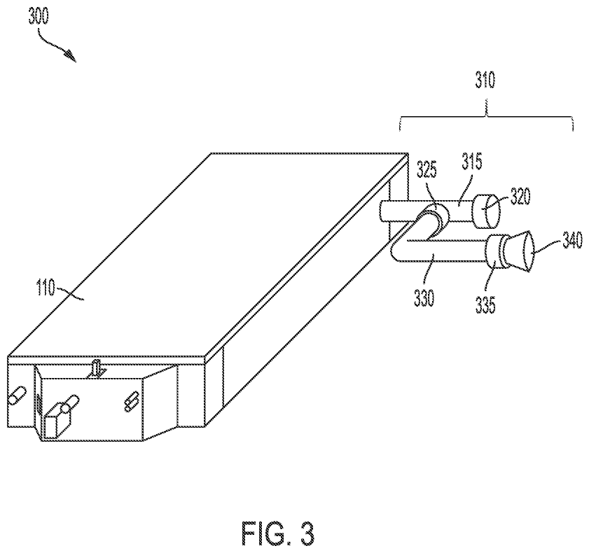

FIG. 3 depicts an example perspective view of a system 300 of the vehicle 105. For example, the system 300 can include at least one portion of the battery pack 110 or an apparatus 310 coupled with a portion of the battery pack 110. The apparatus 310 can include one or more components to detect a thermal event within the battery pack 110 or alert an occupant of the vehicle 105 of the thermal event. The apparatus 310 can include a first conduit 315 coupled with at least a portion of the battery pack 110. For example, the first conduit 315 can fluidly couple with a portion of the battery pack 110 (e.g., with a portion of the battery pack housing 205) such that fluid can flow from within the housing 205 of the battery pack through the first conduit 315. The first conduit 315 can include or can be any piping, channel, tube, duct, opening, aperture, or other element that can couple with a portion of the battery pack 110 to receive one or more gases (e.g., air, gas, combination of air or gas, pressurized air or gas, vapor, condensation, heated air or gas, liquids, combination of gas or liquid, or other fluids) from within a portion of the battery pack 110. For example, the first conduit 315 can receive one or more gases produced from the battery cells 120 (e.g., hydrogen, oxygen, or various other gases). The one or more gases produced from the battery cells 120 can be produced as a result of normal operations of the vehicle 105. For example, the gas can be produced as a result of battery cell charging or battery cell discharging. The gas can be produced before, during, or after operation of one or more components of the vehicle 105. For example, the gas can be produced during charging of the vehicle 105, while the vehicle 105 is being operated (e.g., driving), or after the vehicle 105 is turned off. The first conduit 315 can have various sizes, shapes, or configurations. The first conduit 315 can be cylindrical, rectangular, conical, spherical, any combination thereof, or another variation of shapes. The first conduit 315 can include at least one hollow portion for receiving the one or more gases.

The apparatus 310 can include at least one first valve 320 coupled with a portion of the first conduit 315. The first valve 320 can be or can include various types of valves, flow regulators, or other devices such as, but not limited to, pressure relief valves (PRV), pressure safety valves (PSV), diaphragm valves, or other valve elements. The first valve 320 can fluidly couple with the first conduit 315 such that any fluid (e.g., liquid, gas) flowing through or within the first conduit 315 can potentially flow through, or engage with, the first valve 320. The first valve 320 can allow gas to pass from the battery pack 110 through the first valve 320 at a first pressure. For example, the first valve 320 can be or can include a self-operating valve (e.g., a PRV) such that the first valve 320 is normally closed (e.g., not actuated or not allowing gas flow) and opens only when sufficient pressure of gas or other fluids develops across, adjacent, or otherwise near the valve 320 to actuate the first valve 320.

The first pressure can be associated with gas emitted from the battery pack 110 during normal operation of the battery pack 110. The first valve 320 or the first conduit 315 can form a portion of a ventilating or exhaust system of the battery pack 110, as an example. For example, charging or discharging one or more battery cells 120 of the battery pack 110 can cause the battery cells 120 to release one or more gases. For example, the gases released from the battery cells 120 can apply about 100 kPa of pressure at the first valve 320. The first valve 320 can actuate (and allow the gas to pass through the valve) at least at a pressure of 100 kPa or higher, such that the gas can flow through the first valve 320 and out of the battery pack 110 and the first conduit 315. This example is for illustrative purposes only. The first pressure can be lesser or greater than 100 kPa. For example, the first pressure can be between 0 kPa and 50 kPa, between 0 kPa and 100 kPa, between 100 kPa and 200 kPa, or within another range. The first pressure can be 1 MPa, as another example.

The first pressure can be associated with a pressure differential of gas between an area that is exterior to the battery pack 110 (e.g., the ambient, the environment surrounding the battery pack 110 and the apparatus 310) and an area that is at least partially interior to or coupled with the battery pack 110 (e.g., within the battery pack 110, within a component of the apparatus 310). For example, at the first valve 320, the first pressure can be associated with a pressure difference between an interior side of the valve 320 (e.g., within the first conduit 315) and an exterior side of the valve 320 (e.g., a side opposing the first conduit 315). The first pressure can be a pressure of about 50 kPa. This example is for illustrative purposes only. The first pressure can be lesser or greater than 50 kPa. For example, the first pressure can be between 0 kPa and 50 kPa, between 50 kPa and 100 kPa, or within another range.

The apparatus 310 can include at least one second valve 325. The second valve 325 can couple with a portion of the first conduit 315. For example, the first valve 320 can couple with a first portion of the first conduit 315 and the second valve 325 can couple with a second portion of the first conduit 315. The first portion can be separate from or adjacent to the second portion. The second valve 325 can be or can include various types of valves, flow regulators, or other devices such as, but not limited to, pressure relief valves (PRV), pressure safety valves (PSV), diaphragm valves, or other valve elements. The second valve 325 can fluidly couple with the first conduit 315 such that fluid (e.g., liquid, gas) flowing through or within the first conduit 315 (e.g., gas produced from one or more components of the battery pack 110) can potentially flow through, or engage with, the second valve 325. The gas flowing through the second valve 325 can have one or more different features than the gas flowing through the first conduit 315. For example, one or more molecules of the gas can exit the first conduit 315 through the first valve 320 and one or more different molecules of the gas can exit the first conduit 315 through the second valve 325, such that the gas flowing through the second valve 325 can include one or more different features of the gas flowing through the first valve 320. The second valve 325 can allow the gas to pass from the battery pack 110 through the second valve 325 at a second pressure. For example, the second valve 325 can be or can include a self-operating valve (e.g., a PRV) such that the second valve 325 is normally closed (e.g., not actuated or not allowing gas flow) and opens only when sufficient pressure of gas or other fluids develops across, adjacent, or otherwise near the second valve 325 to actuate the second valve 325.

The second pressure can be associated with gas emitted from the battery pack 110 during a thermal event occurring at least partially within the battery pack 110. For example, the temperature of one or more of the battery cells 120 of the battery pack 110 can cause the battery cells 120 to release gases. As an illustrative example, the gas released can apply about 300 kPa of pressure to the second valve 325. The second valve 325 can actuate (and allow the gas to pass through the valve) at least at a pressure of 300 kPa or higher, such that the gas can flow through the second valve 325 and out of the battery pack 110 and the first conduit 315. This example is for illustrative purposes only. The second pressure can be significantly lesser or significantly greater than 300 kPa. For example, the second pressure can be between 0 kPa and 50 kPa, between 0 kPa and 100 kPa, between 100 kPa and 200 kPa, or within another range. The second pressure can be 1 MPa, as another example.

The second pressure can be associated with a pressure differential of gas between an area that is exterior to the battery pack 110 (e.g., the ambient, the environment surrounding the battery pack 110 and the apparatus 310) and an area that is at least partially interior to or coupled with the battery pack 110 (e.g., within the battery pack 110, within a component of the apparatus 310). For example, at the second valve 325, the second pressure can be associated with a pressure difference between an interior side of the valve 325 (e.g., within the first conduit 315) and an exterior side of the valve 325 (e.g., within the second conduit 330, exterior to the second conduit 330, or another area). The second pressure can be a pressure of about 50 kPa or greater. This example is for illustrative purposes only. The first pressure can be lesser or greater than 50 kPa. For example, the first pressure can be between 0 kPa and 50 kPa, between 50 kPa and 100 kPa, or within another range.

The second pressure can exceed the first pressure. For example, as described above, the first pressure can be the pressure of gas that causes the first valve 320 to actuate to release gas formed by one or more components of the battery pack 110 during normal operation (e.g., charging the battery cells 120, discharging the battery cells 120, operating one or more components of the vehicle 105, or another operating). The second pressure can be the pressure of gas that causes the second valve 325 to actuate during a thermal event (e.g., heating of one or more battery cells, gas production, or another event). As gas can be caused by a thermal event, the second pressure (e.g., the second pressure threshold value) can be greater than the first pressure (e.g., the first pressure threshold value) during or subsequent to a thermal event. The first valve 320 can allow gas to pass through the first valve at the second pressure. For example, if the first pressure threshold is about 100 kPa, and the second pressure threshold is about 300 kPa, the first valve 320 can allow gas to pass at any pressure at or above 100 kPa (including 300 kPa). This example is for illustrative purposes only. The first and second pressure threshold values can be significantly lesser or significantly greater than the values provided in this example. For example, the first pressure can be between 0 kPa and 100 kPa, between 100 kPa and 200 kPa, or within another range. The second pressure can be between 0 kPa and 100 kPa, between 100 kPa and 200 kPa, or within another range. The first pressure can be about 1 MPa and the second pressure can above 1 MPa, as another example.

The second valve 325 can couple with a portion of a second conduit 330. The second conduit 330 can include or can be any piping, channel, tube, duct, opening, aperture, or other element that can couple with a portion of the second valve 325 to receive one or more gases from a portion of the battery pack 110. For example, the second conduit 330 can receive one or more gases produced from the battery cells (e.g., hydrogen, oxygen, or other various gases) as a result of a thermal event (e.g., upon actuation of the second valve 325). The second conduit 330 can have various sizes, shapes, or configurations. The second conduit 330 can be cylindrical, rectangular, conical, spherical, any combination thereof, or another variation of shapes. The second conduit 330 can include at least one hollow portion to receive one or more gases.

The first conduit 315 and the second conduit 330 can include various sizes or shapes. For example, the first conduit 315 and the second conduit 330 can differ in size or shape. The first conduit 315 and the second conduit 330 can include the same size or shape, as another example. In an illustrative example, the first conduit 315 can be approximately 5-200 mm long (e.g., in a direction parallel with the flow of gas) and the second conduit 330 can be approximately 5-200 mm long. This example is for illustrative purposes only. The first conduit 315 or the second conduit 330 can be significantly longer or significantly shorter than 5-200 mm long. For example, the first conduit 315 or the second conduit 330 can be about 0.5 mm long. The first conduit 315 or the second conduit 330 can be about 10 m long, as another example.

The apparatus 310 can include at least one noise generating element 340. For example, the noise generating element 340 can be or can include any element that produces an audible or detectable sound (e.g., a sound detectable by one or more occupants of the vehicle 105). The apparatus 310, or another portion of the vehicle 105, can include one or more components to amplify the sound produced by the noise generating element 340. For example, the vehicle 105 can include an amplifier or a speaker coupled with a portion of the battery pack 110 or a portion of the apparatus 310 to amplify sound produced by the noise generating element 340. For example, the apparatus 310 or another portion of the vehicle 105 can include a hollow tube coupled with one or more portions of the apparatus 310 (e.g., with a portion of the first conduit 315, with the second conduit 330, with a portion of the battery pack 110) to propagate the sound towards an occupant of the vehicle 105. As another example, the apparatus 310 may not include any amplifiers.

The noise generating element 340 can couple with at least a portion of the second conduit 330. For example, the noise generating element 340 can couple with a third valve 335 that is fluidly coupled with the second conduit 330. The noise generating element 340 can couple with in interior or exterior of the second conduit 330, as another example. The noise generating element 340 can couple with a portion of the second valve 325, as another example. The noise generating element 340 can activate (e.g., generate or produce an audible sound) based on the second pressure. For example, the noise generating element 340 can activate in response to actuation of the second valve at or above the second pressure value. As another example, the noise generating element 340 can activate in response to actuation of another component of the apparatus 310 (e.g., a third valve 335 described in greater detail below) based on the second pressure or another pressure value associated with or dependent on the second pressure (e.g., in response to the thermal event).

The noise generating element 340 can include a whistle, as shown in at least FIG. 3. For example, the whistle can be or can include any equipment, instrument, pipe, or apparatus that can produce sound from a stream of fluid (e.g., gas or liquid). The whistle can include at least one opening, aperture, or other feature for gas to flow through. For example, the whistle can couple with a portion of the third valve 335 such that the gas produced by one or more components of the battery pack 110 that flows through the second conduit 330 can flow through the third valve 335 and through at least a portion of the whistle to produce the audible sound. The gas flowing throughout one or more portions of the apparatus 310 (e.g., through the second conduit 330, through the third valve 335, or through the whistle) can have one or more different features than the gas flowing through the first conduit 315, or through another portion of the apparatus 310. For example, one or more molecules of the gas can exit the first conduit 315 through the first valve 320 and one or more different molecules of the gas can exit the first conduit 315 through the second valve 325, such that the gas flowing through the second valve 325 can include one or more different features of the gas flowing through the first valve 320. The third valve 335 can be or can include various types of valves, flow regulators, or other devices such as, but not limited to, pressure relief valves (PRV), pressure safety valves (PSV), diaphragm valves, or other valve elements. The third valve 335 can actuate at or above a third pressure. The third pressure can be greater than or equal to the second pressure (e.g., the pressure at which the second valve 325 actuates). The third pressure can be less than the second pressure. The third pressure can be the pressure value threshold of gas pressurizing the third valve 335 that causes the third valve 335 to actuate. For example, the third pressure can be the pressure value at which gas within the second conduit 330 pressurizes to a threshold that produces a constant flow of gas through the third valve 335.

The third valve 335 can facilitate regulating the flow of gas flowing within the second conduit 330. For example, the third valve 335 can actuate at the third pressure value threshold (e.g., at or above the third pressure) such that gas flows at least partially steadily (e.g., within a specific range of flow velocity) through a portion of the whistle to cause an audible sound (e.g., whistle, sough, screech, alarm, tone, vibration, ringing, static, racket, etc.). The whistle can include a variety of shapes, sizes, and other geometric features to produce a sound. The whistle can be made of various materials including metallic materials (e.g., aluminum, steel, copper, or other metallic materials) or non-metallic materials (e.g., plastic, rubber, or other non-metallic materials). The whistle can be sized and shaped based on a predetermined K-factor, location of the third valve 335, or based on another component of the system 300.

The whistle can activate for a period of time. For example, the third valve 335 can regulate the flow of gas flowing through the second conduit 330 such that gas flows steadily through the third valve 335, and at least partially through a portion of the whistle, such that the whistle causes a detectable sound for a period of time (e.g., 1 second, 5 seconds, 10 seconds, 5 minutes, or another period of time). The whistle can activate for as long as gas is produced from the thermal event within the battery pack 110, for example. For example, the whistle can activate at or above the second pressure value. In other words, the whistle can activate (e.g., produce a detectable sound) as long as gas flows from the battery pack 110 and through the second conduit 330 (or through the third valve 335).

The whistle can produce a sound that is audible outside of the battery pack 110. For example, the whistle can produce a sound that is audible to a human ear such that one or more occupants of the vehicle 105, one or more occupants in a nearby vehicle, or one or more people positioned near the vehicle 105, can hear or detect the sound. For example, the whistle can cause a sound in a frequency range from about 15 Hz to 20 kHz. The whistle can produce a sound that is detectable by a machine or by a human ear. For example, the whistle can cause a sound in a frequency range of 0 to 15 Hz. As another example, the whistle can cause a sound up to 150 dB (e.g., anywhere from 0 dB to 150 dB). As described herein, the noise generating element 340 or another portion of the vehicle 105 can include an amplifier or a speaker coupled with a portion of the battery pack 110 or a portion of the apparatus 310 to amplify sound produced by the noise generating element 340 (e.g., the whistle) such that the sound produced by the whistle can be heard outside of the battery pack 110 by a human ear.

The first valve 320, the second valve 325, and the third valve 335 can include various sizes or shapes. For example, the first valve 320, the second valve 325, and the third valve 335 can differ in size or shape. The first valve 320, the second valve 325, and the third valve 335 can include the same size or shape.

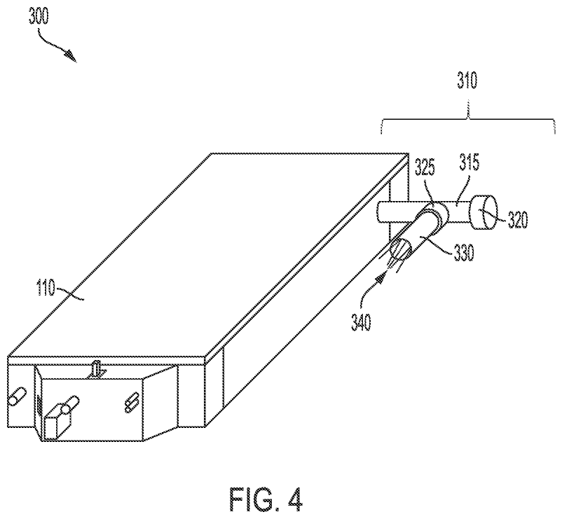

FIG. 4 depicts an example perspective view of the system 300. As shown in at least FIG. 4, the noise generating element 340 can include at least one projection coupled with the second conduit 330. The projections can couple with an internal portion of the second conduit 330. For example, the projections can be formed with an internal portion (e.g., a hollow portion that receives gas) of the second conduit (e.g., formed during manufacturing of the second conduit 330). The projections can couple with an internal portion of the second conduit 330 by one or more fasteners, welded joints, adhesives, or other components, as another example. The projections can couple with one or more portions of the second valve 325 coupled with the second conduit 330, as yet another example.

The projections can be or can include one or more extensions, plates, tabs, discs, sheets, rods, strips, or other components that can couple with a portion of the second conduit 330 such that gas flowing through or within the second conduit 330 (e.g., with or after actuation of the second valve 325) can cause at least one of the projections to move relative to the second conduit 330. For example, the projections can at least partially rotatably couple with an interior section of the second conduit 330 such that gas flowing through the interior section of the second conduit 330 causes at least one projection to move, vibrate, or rotate relative to the second conduit 330 to cause an audible sound.

The noise generating element 340 can include a plurality of projections (e.g., 3 projections, 5 projections, 10 projections, 15 projections, more than 15 projections, or another amount of projections) such that gas flowing through an interior section of the second conduit 330 causes at least one projection to move, rotate, or vibrate or engage with (e.g., contact) a portion of another projection or with a portion of the second conduit 330 to create an audible sound. The projections can be made from a variety of metallic materials or non-metallic materials including, but not limited to, aluminum, steel, copper, ceramic, plastic, or other materials. For example, the projections can be plates, strips, or sheets of metal coupled with an end portion of the second conduit 330, as shown in at least FIG. 4, such that the flow of gas through or within the second conduit 330 causes the metal plates to contact one another (e.g., due to vibrations of the strips caused by the flow of gas) and create an audible sound (e.g., rattling, clashing, or another sound).

The projections can produce a sound that is audible outside of the battery pack 110. For example, the projections can produce a sound such that is audible by a human ear such that one or more occupants of the vehicle 105, or one or more people positioned near the vehicle 105, can hear or detect the sound. For example, the projections can cause a sound in a frequency range from about 15 Hz to 20 kHz. The projections can produce a sound that is detectable by a machine or by a human ear. For example, the projections can cause a sound in a frequency range of 0 to 15 Hz. As another example, the projections can cause a sound up to 150 dB (e.g., anywhere from 0 dB to 150 dB). As described herein, the noise generating element 340 or another portion of the vehicle 105 can include an amplifier or a speaker coupled with a portion of the battery pack 110 or a portion of the apparatus 310 to amplify sound produced by the noise generating element 340 (e.g., the projections) such that the sound produced by the projections can be heard outside of the battery pack 110 by a human ear.

The projections can include various sizes, shapes, or orientations. For example, the projections can extend at an angle relative to one another (e.g., such that at least two projections are not parallel). As another example, the projections can extend at an angle relative to the second conduit 330 or relative to the second valve 325 (e.g., such that at least one projection is not parallel with a central axis of the second conduit 330 or second valve 325). The projections can include a rectangular shape. The projections can include various other shapes including, but not limited to, cylindrical shapes, triangular shapes, or another variation of shape. For example, the projections can include a rectangular shape, a square shape, a serpentine shape, a symmetrical or asymmetrical shape, a circular shape, a spherical shape, an evenly weighted shape or an unevenly weighted shape, any combination thereof, or another type of shape.

The projections can couple directly with a portion of the battery pack 110. For example, the projections can couple with a portion of the battery pack housing 205. The projections can be formed with the battery pack housing 205 (e.g., formed during manufacturing of the housing 205), as an example. The projections can be coupled with the battery pack housing 205 post-manufacturing of the housing 205, as another example. For example, the projections can couple with one or more portions of the battery pack 110 through welding, adhesives, fasteners, clamps, clips, or other elements. The projections can extend at least partially into an opening or aperture of the battery pack housing 205 such that gas exiting the battery pack housing 205 causes the projections to move, vibrate, rotate, or otherwise engage one another to cause an audible sound.

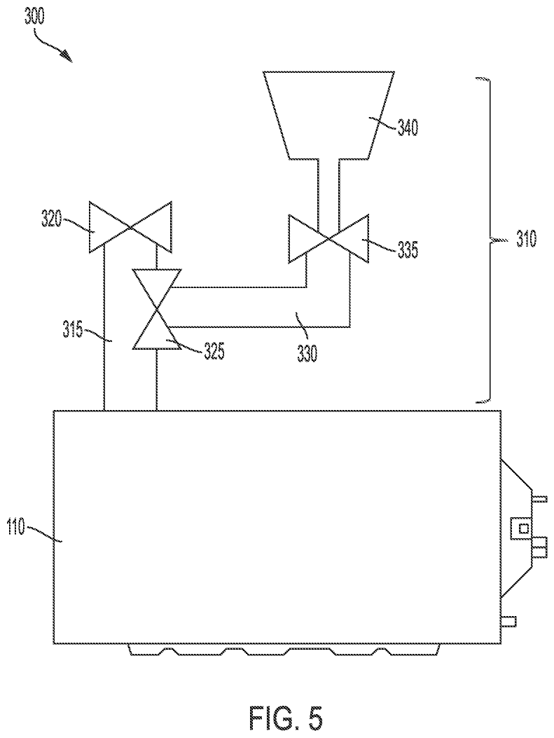

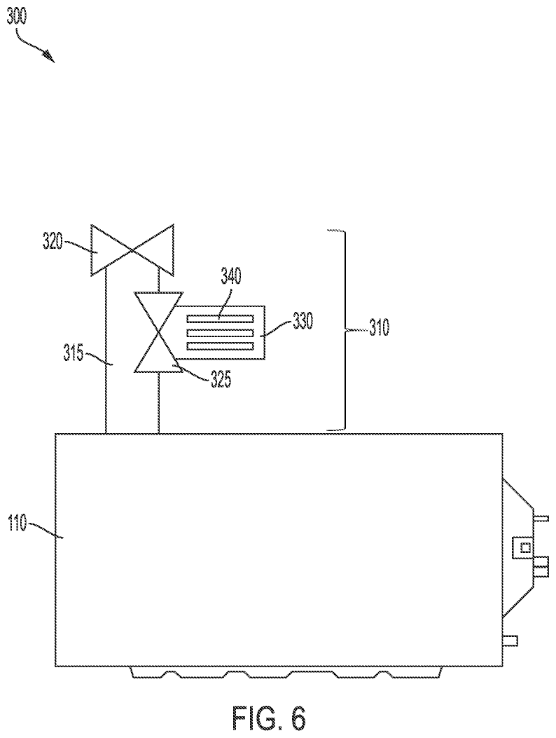

FIG. 5 depicts an example top view of the system 300 having the whistle (e.g., as shown in FIG. 3) and FIG. 6 depicts a top view of the system 300 having the one or more projections (e.g., as shown in FIG. 4). The system 300 can include more than one noise generating element 340. For example, the system 300 can include both the whistle and the projections. The whistle and the projections can couple with the second conduit 330. For example, the whistle can couple with the third valve 335 coupled with the second conduit 330. The projection can couple with the second valve 325, the second conduit 330, or with the third valve 335, as another example. Both the whistle and the projections can activate based on the second pressure (e.g., during a thermal event of the battery pack 110).

The apparatus 310 can position at various locations of the battery pack 110. For example, the apparatus 310 can position along a side of the battery pack 110 (e.g., along a side of the battery pack 110 such that at least one portion of the apparatus 310 extends in an outward direction relative to a side of the vehicle 105). As another example, the apparatus 310 can position along a top or bottom section of the battery pack 110, such that at least a portion of the apparatus 310 extends in an upward or downward direction relative to the vehicle 105. The vehicle 105 can include a plurality of apparatuses 310. For example, the vehicle 105 can include a first apparatus 310, or at least one component of the apparatus 310, coupled with a first portion of the battery pack 110 and at least one second apparatus 310, or at least a second component of the apparatus 310, coupled with a second portion of the battery pack 110. For example, a first apparatus 310 can position about adjacent to a first battery module 115 and a second apparatus 310 can position about adjacent to a second battery module 115 within the battery pack 110.

The position of the apparatus 310 relative to the battery modules 115 of the battery pack 110 can vary. For example, the first conduit 315 can position substantially near to one or more modules 115 of the battery pack 110 (e.g., within 10 mm, within 50 mm, within 100 mm, or within another distance). The first conduit 315 can position substantially distant from (e.g., at least 100 mm away from, at least 250 mm away from, or another distance) one or more modules 115 of the battery pack 110, as another example. These examples are for illustrative purposes only. The battery pack 110, the system 300, and various components thereof can vary significantly in size. For example, the first conduit 315 can be positioned within 1 mm of a battery module 115. The first conduit 315 can be positioned within 5 m of a battery module 115, as another example. The first conduit 315 can be positioned more than 5 m away from a battery module 115, as another example.

At least one of the first pressure threshold value, the second pressure threshold value, or the third pressure threshold value can depend on, or be associated with, the location of the apparatus 310 relative to one or more components of the battery pack 110. For example, the first pressure threshold value can be greater when the first conduit 315 is positioned substantially close to a battery module 115 (e.g., when the first conduit 315 is positioned anywhere between 1 mm and 100 mm away from a battery module 115, between 100 mm and 200 mm away, or within another range) than when the first conduit 315 is positioned substantially far from a battery module 115 (e.g., when the first conduit 315 is positioned more than 10 mm away, more than 100 mm away, or another distance away from the battery module 115). The first pressure threshold value can be lesser when the size of the battery pack housing 205 is large (e.g., 10% larger than one or more battery modules 115, 20% larger than one or more battery modules 115, or another size) as compared to when the size of the battery pack housing 205 is small (e.g., 1% larger than one or more battery modules 115, 5% larger than one or more battery modules 115, or another size). The first pressure threshold value can be greater when the size of the first conduit 315 is large (e.g., 10% smaller than the housing 205 of the battery pack 110, 20% smaller than the housing 205 of the battery pack 110, or another size) as compared to when the size of the first conduit 315 is small (e.g., 90% smaller than the housing 205 of the battery pack 110, 80% smaller than the housing 205 of the battery pack 110, or another size).

The size or shape of the first valve 320, the second valve 325, or the third valve 335 can depend on, or be associated with, the location of the apparatus 310 relative to one or more components of the battery pack 110 or the pressure threshold values. For example, the first valve 320 can be larger (e.g., between 100 and 200 mm, between 200 and 300 mm, or within another range) when the first conduit 315 is positioned close to a battery module 115 (e.g., within 1 mm, within 10 mm, within 100 mm, or within another distance of the battery module 115) than when the first conduit 315 is positioned far from a battery module 115 (e.g., within 200 mm, within 300 mm, or within another distance of the battery module 115). As another example, the first valve 320 can vary in size dependent on the first pressure value, the second valve 325 can vary in size dependent on the second pressure value, or the third valve 335 can vary in size dependent on the third pressure value.

The system 300 can include at least one additional conduit or other component to facilitate releasing gas through the apparatus 310. For example, the apparatus 310 or the battery pack 110 can include one or more hoses, ducts, tubes, or other elements to facilitate releasing gas from within the battery pack housing 205.

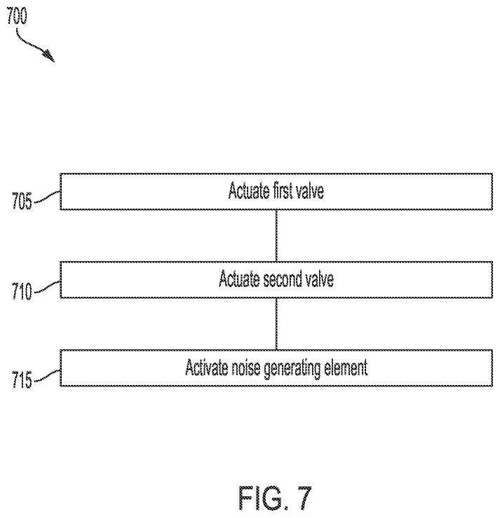

FIG. 7 depicts an example illustration of a method 700 of generating a noise. The method 700 can include actuating the first valve 320, as depicted in act 705. For example, the first valve 320 can actuate at or above the first pressure value. The first valve 320 can actuate due to gas flowing through the first conduit 315 and pressurizing the first valve 320 fluidly coupled with the first conduit 315 at or above the first pressure value. The first pressure value can be associated with pressure of gas flowing through the first conduit 315 during normal operation of the battery pack 110 (or the vehicle 105). For example, the first pressure value can be associated with pressure of gas flowing through the first conduit 315 caused by charging the battery cells 120, discharging the battery cells 120, operating the vehicle 105, or another operating condition.

The method 700 can include actuating the second valve 325, as depicted in act 710. For example, the second valve 325 can actuate at or above the second pressure value. The second valve 325 can actuate due to gas flowing through the first conduit 315 and pressurizing the second valve 325 fluidly coupled with the first conduit 315 at or above the second pressure value. The second pressure value can be associated with pressure of gas flowing through the first conduit 315 during or outside of normal operation of the battery pack 110 (or the vehicle 105). For example, the second pressure value can be associated with pressure of gas flowing through the first conduit 315 caused by heating of one or more portions of the battery pack 110 (e.g., one or more battery cells 120). The second pressure value can be associated with a thermal event (e.g., heating) of one or more portions of the battery pack 110.

The method 700 can include activating the noise generating element 340, as depicted in act 715. For example, the apparatus 310 can include a second conduit 330 fluidly coupled with the second valve 325 to receive the gas flowing through the second valve 325. The noise generating element 340 can couple with the second conduit 330, or with a component coupled with the second conduit 330, such that the noise generating element 340 creates an audible sound during the thermal event (e.g., upon actuation of the second valve 325). The noise generating element 340 can include a whistle (e.g., an instrument to produce sound caused by air flowing through the instrument). The apparatus 310 can include a third valve 335 to regulate the flow of gas through the whistle such that the whistle can activate for a period of time. The noise generating element can include one or more projections (e.g., extensions, tabs, protrusions, plates, slabs, strips, etc.) that vibrate or move due to gas flowing through the second conduit 330.

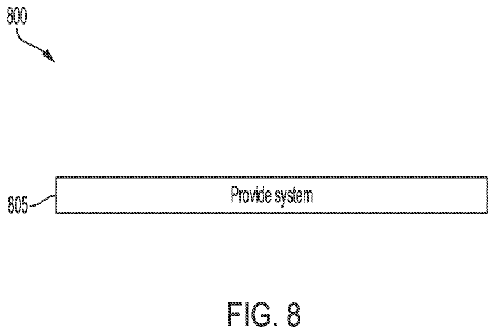

FIG. 8 depicts an example illustration of a method 800. The method 800 can include providing the system 300, as depicted in act 805. For example, the system 300 can include the first conduit 315 coupled with a portion of the battery pack 110. The system 300 can include the first valve 320 fluidly coupled with the first conduit 315 such that the first valve 320 can release gas from within the first conduit 315 at or above a first pressure (e.g., caused by gas pressurizing the first valve 320). The system 300 can include the second valve 325 fluidly coupled with the first conduit 315 such that the second valve 325 can release gas from within the first conduit 315 at or above a second pressure (e.g., caused by gas pressurizing the second valve 325). The second pressure can exceed the first pressure. For example, the first valve 320 can actuate at a pressure value that is lower than the threshold pressure value of the second valve 325. The second pressure can be associated with the release of gas caused by a thermal event of the battery pack 110. The system 300 can include a second conduit 330 fluidly coupled with the second valve 325. The system 300 can include one or more noise generating elements 340 coupled with the second conduit 330 or with the second valve 325. For example, the system 300 can include a whistle coupled with the second conduit 330 by a third valve 335 that regulates flow of gas through the whistle. The system 300 can include a plurality of projections coupled with the second conduit 330 or with the second valve 325 that vibrate or move due to flow of gas within the second valve 325 or second conduit 330. The whistle or the projections can cause an audible sound to alert an occupant of the vehicle 105 of the thermal event.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure. For example, the apparatus 310 can be configured in various other components or systems, such as a combustion engine or another gas-releasing system. The apparatus 310 can apply to any vehicle operating mode including during driving, parking, charging (e.g., AC or DCFC), or various other modes. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a first conduit coupled with a battery pack;
a first valve coupled with the first conduit, the first valve configured to allow gas to pass from the battery pack through the first valve at a first pressure;
a second valve coupled with the first conduit and with a second conduit, the second valve configured to allow the gas to pass at a second pressure, the second pressure greater than the first pressure; and
a noise generating element coupled with the second conduit, the noise generating element configured to activate based on the second pressure.

2. The apparatus of claim 1, comprising:
a third valve coupled with the second conduit, the third valve configured to allow the gas to pass at a third pressure; and
the noise generating element including a whistle coupled with the third valve, the whistle configured to activate responsive to actuation of the third valve to generate an audible sound.

3. The apparatus of claim 1, comprising:
the noise generating element is a plurality of projections coupled with the second conduit, the plurality of projections configured to cause an audible sound responsive to actuation of the second valve; and
wherein the audible sound is audible outside of the battery pack.

4. The apparatus of claim 1, comprising:
a third valve coupled with the second conduit, the third valve configured to allow the gas to pass at a third pressure;
the noise generating element including a whistle coupled with the third valve, the whistle configured to activate responsive to actuation of the third valve to generate an audible sound; and
wherein the whistle is configured to activate for a period of time.

5. The apparatus of claim 1, comprising:
a third valve coupled with the second conduit, the third valve configured to allow the gas to pass at a third pressure, the third pressure greater than the second pressure; and
the noise generating element including a whistle coupled with the third valve, the whistle configured to activate responsive to actuation of the third valve to generate an audible sound.

6. The apparatus of claim 1, comprising:
the noise generating element is a plurality of projections coupled with a portion of the battery pack, the plurality of projections configured to cause an audible sound based on the second pressure; and
wherein the audible sound is audible outside of the battery pack.

7. The apparatus of claim 1, comprising:
the second pressure is associated with a thermal event of the battery pack.

8. The apparatus of claim 1, comprising:
the noise generating element is a plurality of projections coupled with the second conduit, the plurality of projections configured to cause an audible sound responsive to actuation of the second valve; and
wherein the plurality of projections are coupled at an end portion of the second conduit.

9. The apparatus of claim 1, comprising:
the noise generating element is a plurality of projections coupled with the second conduit, the plurality of projections configured to cause an audible sound responsive to actuation of the second valve; and
wherein the plurality of projections are rotatably coupled to the second conduit such that the gas flowing through the second conduit causes a projection of the plurality of projections to rotate relative to the second conduit.

10. A method, comprising:
actuating, at a first pressure, a first valve coupled with a first conduit, the first valve configured to allow gas to pass from a battery pack through the first valve;
actuating, at a second pressure greater than the first pressure, a second valve coupled with the first conduit and with a second conduit; and
activating a noise generating element coupled with the second conduit based on the second pressure.

11. The method of claim 10, comprising:
actuating, at a third pressure, a third valve coupled with the second conduit, the third valve configured to allow the gas to pass at the third pressure; and
wherein activating the noise generating element includes activating a whistle coupled with the third valve, the whistle configured to activate responsive to actuation of the third valve to generate an audible sound.

12. The method of claim 10, comprising:
wherein activating the noise generating element includes activating a plurality of projections coupled with the second conduit, the plurality of projections configured to cause an audible sound responsive to actuation of the second valve; and
wherein the audible sound is audible outside of the battery pack.

13. The method of claim 10, comprising:
actuating, at a third pressure, a third valve coupled with the second conduit;
wherein activating the noise generating element includes activating a whistle coupled with the third valve, the whistle configured to activate responsive to actuation of the third valve to generate an audible sound; and
wherein the whistle is configured to activate for a period of time.

14. The method of claim 10, comprising:
actuating, at a third pressure, a third valve coupled with the second conduit, the third pressure greater than the second pressure; and
wherein activating the noise generating element includes activating a whistle coupled with the third valve, the whistle configured to activate responsive to actuation of the third valve to generate an audible sound.

15. The method of claim 10, comprising:
wherein activating the noise generating element includes activating a plurality of projections coupled with a portion of the battery pack, the plurality of projections configured to cause an audible sound based on the second pressure; and
wherein the audible sound is audible outside of the battery pack.

16. The method of claim 10, comprising:
the second pressure is associated with a thermal event of the battery pack.

17. The method of claim 10, comprising:
wherein activating the noise generating element includes activating a plurality of projections coupled with the second conduit, the plurality of projections configured to cause an audible sound responsive to actuation of the second valve; and
wherein the plurality of projections are coupled at an end portion of the second conduit.

18. An electric vehicle, comprising:
an apparatus including:
a first conduit coupled with a battery pack;
a first valve coupled with the first conduit, the first valve configured to allow gas to pass from the battery pack through the first valve at a first pressure;
a second valve coupled with the first conduit and with a second conduit, the second valve configured to allow the gas to pass at a second pressure, the second pressure greater than the first pressure; and
a noise generating element coupled with the second conduit, the noise generating element configured to activate based on the second pressure.

19. The electric vehicle of claim 18, comprising:
a third valve coupled with the second conduit, the third valve configured to allow the gas to pass at a third pressure; and
the noise generating element is a whistle coupled with the third valve, the whistle configured to activate responsive to actuation of the third valve to generate an audible sound.

20. The electric vehicle of claim 18, comprising:
the noise generating element is a plurality of projections coupled with the second conduit, the plurality of projections configured to cause an audible sound responsive to actuation of the second valve; and
wherein the audible sound is audible outside of the battery pack.
